(19) United States
(12) Patent Application Publication
(10) Pub. No.: US 2026/0312537 A1
(43) Pub. Date: Oct. 8, 2026

(54) UNIMPEDED ROW SYSTEM

(71) Applicant: WTEC, LLC, Hasbrouck Heights, NJ (US)

(72) Inventor: Orin B. Singh, Hasbrouck Heights, NJ (US)

(21) Appl. No.: 19/638,579

(22) Filed: Apr. 3, 2026

Related U.S. Application Data
(60) Provisional application No. 63/782,683, filed on Apr. 3, 2025.

(51) Int. Cl. H02S 40/36; H01B 1/02; H01B 3/42; H01R 4/2487; H02G 9/02; H02G 15/113; H02S 20/10; H02S 40/34

(52) U.S. Cl. CPC H02S 40/36; H01B 1/02; H01B 3/421; H01R 4/2487; H02G 9/02; H02G 15/113; H02S 20/10; H02S 40/34

(57) ABSTRACT

An unimpeded row system for solar arrays using a below-grade trunk bus line with positive and negative conductors installed in a trench along the row of solar panel arrays. Each solar panel array connects to the trunk bus via multi-tap connectors that receive the trunk line and wire harness conductors, eliminating combiner boxes and reducing heat and failure points. One or more hand-hold boxes within the trench provide above-grade access while allowing the trunk bus to pass through. The trunk bus line may be formed from ruggedized, direct-burial cable with dual-layer insulation and aluminum-coated steel core members, minimizing trenching requirements and improving system reliability.

### TECHNICAL FIELD AND BACKGROUND

The present invention relates to electrical interconnection systems for solar power generation, and more specifically, to an unimpeded row system that interconnects photovoltaic (“PV”) arrays in a way that reduces installation complexity, cost, and maintenance challenges.

Conventional solar power systems typically aggregate current from multiple PV arrays through combiner boxes, which then feed into trunk bus lines that transmit power to inverters and ultimately to the grid. While widely used, these systems present several drawbacks. First, they involve high material and labor costs due to the extensive lengths of conductor cable and multiple combiner boxes required, as well as the trenching and conduit placement that demand heavy machinery and skilled labor. Second, maintenance is difficult because electrical bus lines are generally buried, making them inaccessible without excavation, which risks damaging the cables and associated components. Third, combiner boxes handle increasingly large currents as they aggregate power from multiple arrays, leading to overheating and potential failure, which limits scalability and increases operational risk. Finally, conventional designs often require wide trenches and above-grade structures that interfere with site maintenance activities such as mowing.

To address these limitations, the disclosed unimpeded row system introduces a trunk bus architecture that utilizes ruggedized cables, such as the SolarTough® cable, and multi-tap shear bolt connectors. These connectors allow direct electrical connection of PV wire harnesses to the trunk bus without intermediate combiner boxes, significantly reducing heat generation and failure points. The system is installed in a narrow trench with strategically placed hand-hold boxes for easy access, enabling maintenance without disrupting the surrounding environment. Additionally, the use of aluminum-coated steel core conductors provides mechanical strength for self-supporting spans while maintaining electrical conductivity. This design minimizes trenching, improves thermal performance, reduces installation time and cost, and enhances reliability for large-scale solar installations.

### SUMMARY

Disclosed is an unimpeded row system that includes a solar panel array installed on a surface and a trench formed in the surface. The system can also be constructed using a multitude of solar panel arrays arranged in one or more rows where the trench is formed in the ground and extends along the rows of solar panel arrays. In one embodiment, a trunk bus is positioned within the trench. A photovoltaic wire extends from the solar panel array to the trunk bus to place the trunk bus in signal communication with the solar panel array.

The system also includes a multi-tap electrical connector that has a hollow housing defining a through-socket that receives or houses the trunk bus line. The multi-tap connector also has a plurality of taps that are each formed as a conduit extending through the hollow housing to the through-socket, wherein the photovoltaic wire extends through one of the taps. A box is positioned within the trench and includes a first end and a second end. The first end has a first cutout, and the second end has a second cutout. The first cutout and the second cutout each extend from an upper rim toward a lower surface, and the trunk bus line extends through the first cutout end and through the second cutout.

In another aspect of the system, the positive trunk bus has an inner insulation layer formed of cross-linked polyethylene and an outer jacket layer formed of high-density polyethylene. The trunk bus can also be formed with an aluminum-coated steel core member.

The multi-tap electrical connector can include one or more shear-bolt fasteners that extend through a passage formed in the hollow housing and into the trunk bus line. In some embodiments, the box has a first door and a second door, wherein (i) the first door is slidably received within a first channel formed in the first end, and (ii) the second door is slidably received within a second channel formed in the second end. The first door can include a first aperture configured to accommodate the trunk bus line that extends through the aperture, and the second door can include a second aperture configured to accommodate the trunk bus line that extends through the second aperture. The hand-hold box optionally includes a lid that encloses the interior of the hand-hold box where the lid is positioned at or below a grade of the surface (i.e., the ground).

The system can be configured with the multi-tap electrical connector positioned within the interior of the box. An insulating seal can be used to encapsulate the multi-tap electrical connector. The insulating seal takes the form of at least one of a heat-shrink boot, a molded thermoplastic elastomer, or a molded thermoset elastomer.

In another embodiment, the system includes a trunk bus extending along a row of solar panel arrays where the trunk bus has a positive trunk bus line and a negative trunk bus line. Photovoltaic wires extend from each solar panel array, and multi-tap electrical connectors are mounted on the trunk bus.

Each multi-tap electrical connector is formed with hollow housing that has a first opening and a second opening. Each housing defines a socket that extends from the first opening to the second opening, and the socket receives the positive trunk bus or the negative trunk bus that extends through the socket. Each multi-tap connector also has a plurality of taps receiving respective conductors of the photovoltaic wires. A trench is formed to extend along the row of solar panel arrays. A hand-hold box is positioned within the trench. The hand-hold box includes a first end and a second end. The first end has a first cutout, and the second end has a second cutout. The trunk bus line is positioned below a surface grade within the trench and extends through the first cutout of the first end and the second cutout of the second end.

The hand-hold box can include a lid enclosing an interior of the hand-hold box where the lid is positioned at or below the surface grade. For some embodiments, the positive trunk bus and the negative trunk bus each include a conductive cable surrounded by an inner insulation layer formed of cross-linked polyethylene and an outer jacket layer formed of high-density polyethylene. Each multi-tap electrical connector can be formed with a plurality of shear-bolt fasteners extending through passages in the hollow housing of the multi-tap electrical connector and into the trunk bus line to establish a metal-to-metal conductive contact.

The multi-tap electrical connectors can be at least partially encased within an insulating material, and the insulating seal selected from a heat-shrink boot, a molded thermoplastic elastomer, a molded thermoset elastomer, or a field sealing kit. The field sealing kit comprises at least one of an insulating sleeve, a tape, or a semi-solid paste.

Also disclosed is a method of installing an unimpeded row system that includes the step of forming a trench along a row of solar panel arrays. The trench extends below a surface grade, and a trunk bus is positioned below the surface grade within the trench. The method also includes mounting a multi-tap electrical connector on the trunk bus line. The multi-tap electrical connector is at least partially encased with an insulating material or a field sealing kit. The multi-tap electrical connector has a housing that defines a through-socket that receives the trunk bus line and a tap formed on an outer surface of the hollow housing. The steps also include connecting a photovoltaic wire from respective solar panel arrays to the tap. The method further includes positioning a box within the trench such that the trunk bus line extends through the box. The box provides access to the multi-tap electrical connector from above the surface grade, and the box has a first end that has a first channel and a second end that has a second channel. A trunk bus is positioned within the box such that the trunk bus extends from the first channel to the second channel.

In one aspect, the trench is formed by cutting the trench with a bulldozer that has a knife connected to a rear of the bulldozer while simultaneously feeding the positive trunk bus and the negative trunk bus from one or more spools mounted on the bulldozer through a funnel system into the trench.

### BRIEF DESCRIPTION OF THE FIGURES

Features, aspects, and advantages of the present invention are better understood when the following detailed description of the invention is read with reference to the accompanying figures, in which:

FIG. 1 illustrates a conventional configuration for interconnecting solar panel arrays.

FIG. 2 illustrates trunk bus installation through trenching techniques.

FIG. 3 illustrates an unimpeded row system according to one example embodiment.

FIG. 4 illustrates positive and negative trunk buses having multi-tap connectors installed thereon according to one example embodiment.

FIG. 5 depicts an aluminum coated, steel core member extending through a bus line according to one example embodiment.

FIG. 6 is an example multi-tap connector according to one example embodiment.

FIG. 7 is an example multi-tap connector according to one example embodiment.

FIG. 8 is an example multi-tap connector according to one example embodiment.

FIG. 9 is an example heat-shrink boot encapsulating a multi-tap connector according to one example embodiment.

FIG. 10 is an example heat-shrink boot encapsulating a multi-tap connector according to one example embodiment.

FIG. 11 depicts installation of a positive and negative trunk bus according to one example embodiment of the disclosed unimpeded row system.

FIG. 12 illustrates the unimpeded row system installed in a trench and connected to solar panel arrays according to one example embodiment.

FIG. 13 illustrates a hand-hold box of the unimpeded row system of FIG. 12 in a trunk bus installation configuration according to one example embodiment.

FIG. 14 illustrates the hand-hold box of FIG. 13 in an open configuration.

FIG. 15 illustrates the hand-hold box of FIG. 14 in a closed configuration.

FIG. 16 illustrates the unimpeded row system of FIG. 12 fully installed.

### DETAILED DESCRIPTION

The present invention will now be described more fully hereinafter with reference to the accompanying figures in which example embodiments of the invention are shown. However, the invention may be embodied in many different forms and should not be construed as limited to the representative embodiments set forth herein. The example embodiments are provided so that this disclosure will be both thorough and complete and will fully convey the scope of the invention and enable one of ordinary skill in the art to make, use, and practice the invention.

Relative terms such as lower or bottom; upper or top; upward, outward, or downward; forward or backward; and vertical or horizontal may be used herein to describe one element's relationship to another element illustrated in the figures. It will be understood that relative terms are intended to encompass different orientations in addition to the orientation depicted in the drawings. By way of example, if a component in the drawings is turned over, elements described as being on the “bottom” of the other elements would then be oriented on “top” of the other elements. Relative terminology, such as “substantially” or “about,” describe the specified materials, steps, parameters, or ranges as well as those that do not materially affect the basic and novel characteristics of the claimed inventions as a whole (as would be appreciated by one of ordinary skill in the art).

### Solar Panel Array Bus Systems

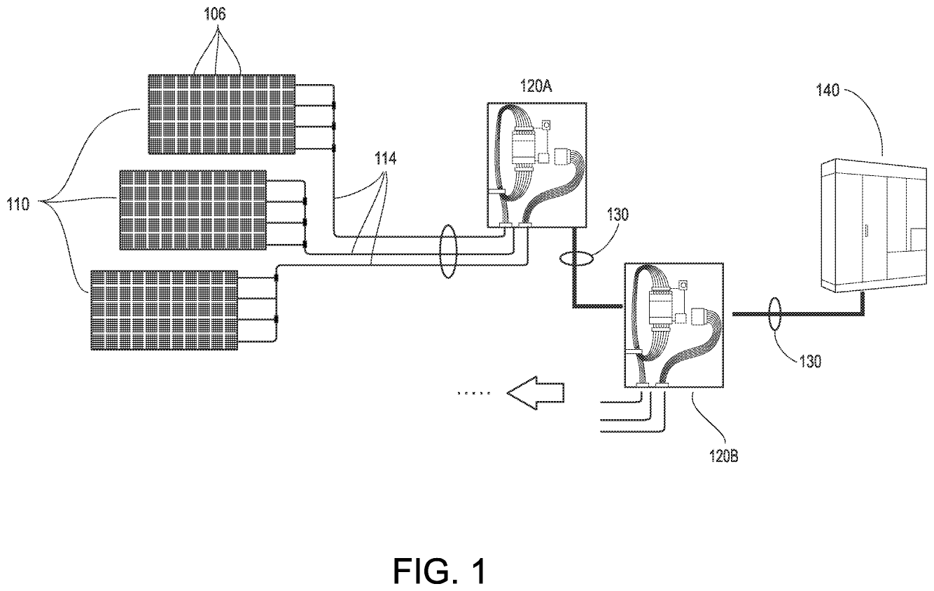

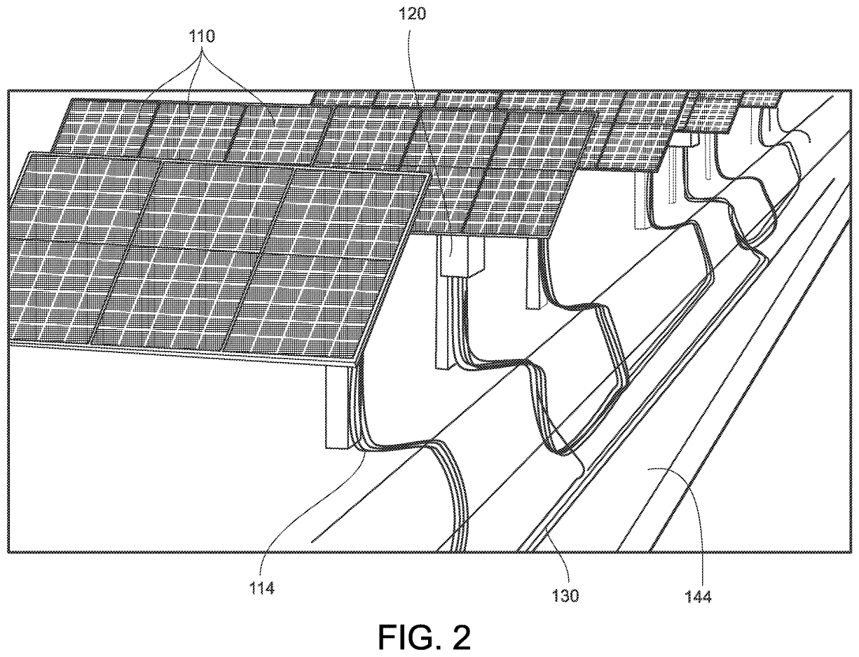

Examples of conventional configurations for electrically interconnecting solar panel arrays are illustrated in FIGS. 1-2. The individual solar panels 106 are arranged into panel arrays 110. Each solar panel array 110 outputs approximately 6 A to 10 A of current through a photovoltaic (“PV”) wire harness 114 that leads to a combiner box 120A & 120B. The current from each panel array 110 is combined within the combiner box 120A & 120B and fed to a trunk bus 130. The trunk bus 130 carries the combined current to an inverter 140 that connects to a disconnect box and to a local power grid.

Note that the example configurations shown in FIGS. 1-2 are illustrative and not intended to be limiting, and there are other potential configurations that can be improved using the inventive systems, components, and methods described in this specification. For instance, FIG. 1 shows three panel arrays 110 and corresponding PV wire harnesses 114 feeding combiner boxes 120A & 120B, but in some configurations there could be ten, twenty, or another predetermined number of solar panel arrays 110 connected to a combiner box 120A & 120B. Moreover, the PV wire harnesses 114 could be connected to an initial feeder bus that extends along a row of panel arrays 110. The feeder bus then connects the panel arrays 110 to the combiner boxes 120A & 120B and trunk bus 130, which is also known as a “home run” to the power station including the inverter 140. In those cases, both the trunk bus 130 and the initial feeder bus could be improved with the self-supporting bus 130 disclosed herein or the use of multi-tap connectors disclosed herein.

The trunk bus 130 includes one or more conductor lines in combination with other lines that run in parallel and provide mechanical support and grounding protection. The trunk bus 130 can include a positive trunk bus line and a negative trunk bus line made from available photovoltaic cable. The positive trunk bus line and negative trunk bus line can be formed as electrically conductive stranded cables surrounded by one or more insulating layers. For higher amperage applications, the positive and negative trunk bus lines are formed as bus bars.

The positive and negative trunk bus lines are optionally housed within the same or within separate conduits (i.e., a hollow plastic or metal tube that houses the bus lines) for mechanical stability and protection against weather elements. The trunk bus 130 can also include a ground cable (also known as a bonding cable). Additionally, the trunk bus 130 can be formed with a grounding line that electrically connects to each of the combiner boxes to protect against instances where a grounded combiner box becomes inadvertently energized.

With reference to FIG. 1, multiple combiner boxes 120A & 120B may be connected in series along the trunk bus 130 such that the current becomes increasingly larger across each combiner box 120A & 120B nearing the inverter 140. To illustrate with reference to the simplified example configuration shown in FIG. 1, the first combiner box 120A accepts input from three solar panel arrays 110 that each have a current output of 6 A-10 A (“A” representing amperes). Assuming for the sake of illustration that each panel array 110 has an output of 10 A at 600 volts direct current (“VDC”). The output of the first combiner box 120A to the trunk bus 130 is then 30 A at 600 VDC. If a second row of three panel arrays (not shown) is connected to the second combiner box 120B, then the output at the second combiner box 120B is 60 A at 600 VDC. Thus, the current and power output, which is proportional to current (i.e., Power=Current×Voltage), are both doubled at the output of the second combiner box 120B.

The increasing current at the output of each combiner box (e.g., 120A & 120B) leads to combiner box overheating and failure and limits the number of solar panel arrays that can be connected along a trunk bus 130. Combiner boxes are difficult to service safely because of the larger currents handled, and connection points within the combiner boxes must be torqued and otherwise installed precisely to avoid current loss that leads to overheating. Moreover, the increasing current requires larger conductor sizes for the trunk bus 130 that can become challenging and costly to install. FIG. 2 depicts a conventional trenching technique for installing a trunk bus.

As illustrated in FIG. 2, conventional trenching techniques involve burying the trunk bus 130 within a trench 144 created adjacent to rows of solar panel arrays 110. This approach requires significant site preparation and the use of heavy equipment, such as backhoes or trenchers, to excavate wide trenches capable of accommodating conduits and bus lines. These operations increase installation time and cost, particularly for large-scale solar farms where hundreds or thousands of feet of trenching may be required. Beyond the initial installation expense, trenching introduces long-term maintenance challenges.

Once the trunk bus 130 is buried, accessing it for inspection, repair, or replacement becomes difficult and disruptive, often requiring excavation that can damage surrounding infrastructure and vegetation. Additionally, buried systems are susceptible to environmental factors such as moisture ingress, soil movement, and rodent damage, which can compromise electrical integrity over time. These disadvantages underscore the need for an alternative interconnection method that minimizes trenching, reduces reliance on heavy machinery, and allows easier access for servicing without compromising system reliability.

### Unimpeded Row System

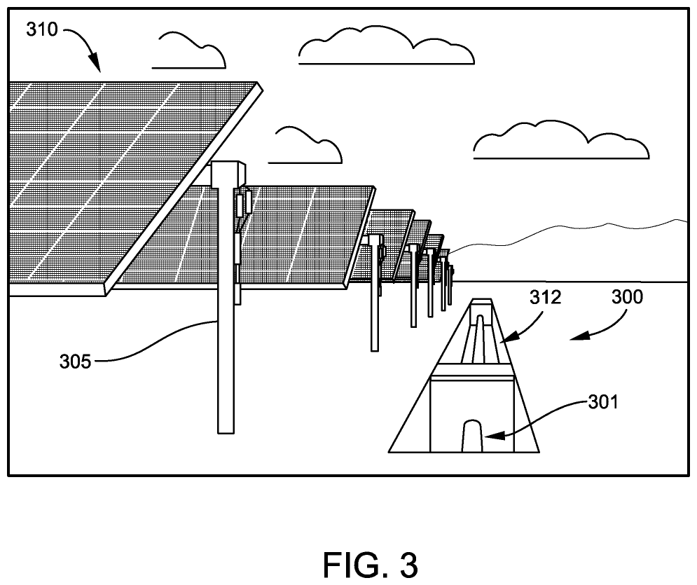

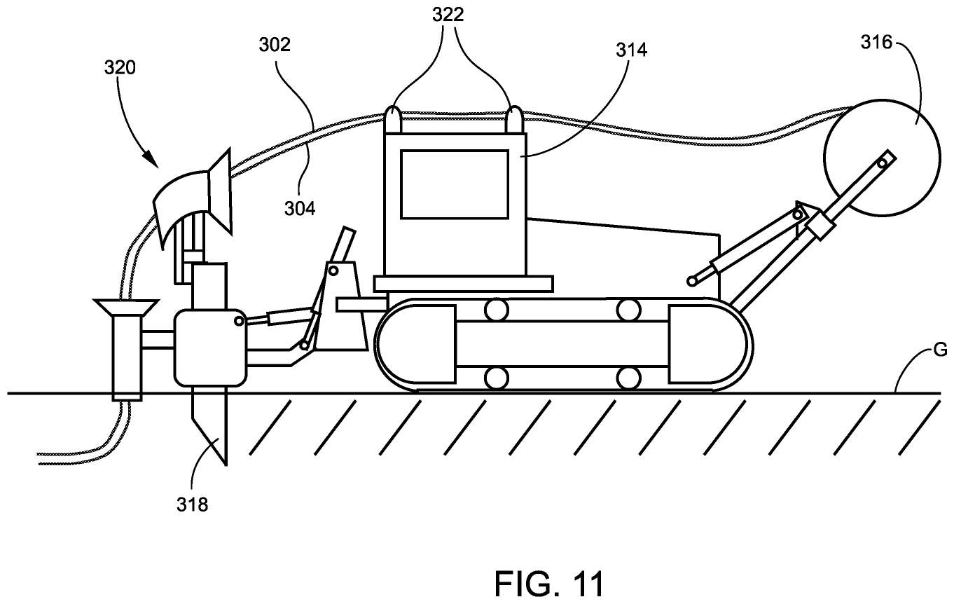

An unimpeded row system 300 according to one embodiment is illustrated in FIG. 3. The system 300 is installed below grade “G” (see FIG. 11) to facilitate routine maintenance around solar panel arrays 310, such as mowing or vegetation control, without interference from above-grade boxes, cables, or other equipment. This below-grade configuration improves site accessibility and aesthetics while reducing hazards associated with exposed electrical components.

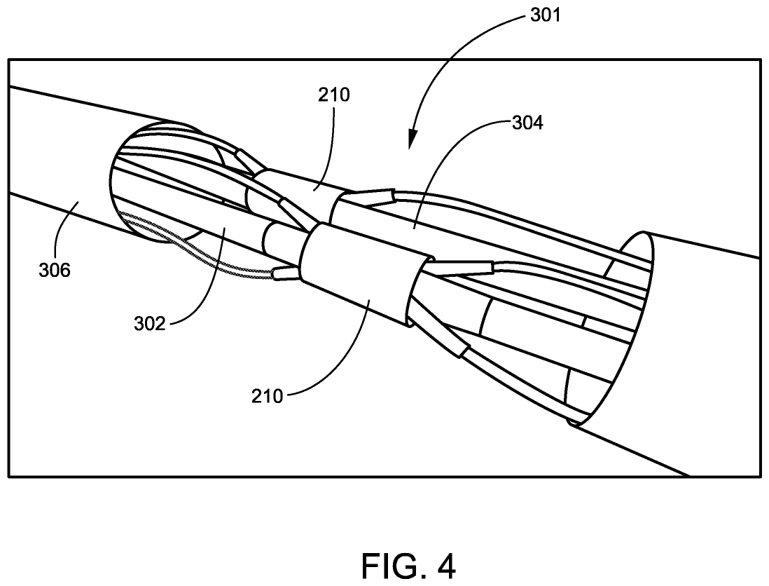

The system 300 includes a trunk bus line 301 comprising a positive trunk bus 302 and a negative trunk bus 304 (see FIG. 4), which serve as the primary conductors for transmitting electrical power from multiple solar arrays to the inverter. In the illustrated embodiment, the trunk bus line utilizes a ruggedized cable, such as the SolarTough® cable, in combination with multi-tap penetrating connectors 210, also referred to herein as multi-tap electrical connectors, that enable direct electrical connection of photovoltaic wire harnesses without intermediate combiner boxes. It should be understood that other suitable cable types may also be employed without departing from the scope of the invention. The SolarTough® cable is specifically designed for direct burial below grade “G,” eliminating the need for a protective sheath or conduit under most conditions; however, as shown in FIG. 4, a conduit 306 may optionally be used to provide additional mechanical protection or environmental sealing where required.

The SolarTough® ruggedized cable includes a conductive cable surrounded by an inner, first insulation layer and an outer, second insulation layer. The thickness of the insulation layers varies according to the size of the conductor cable that the insulation layers surround. Those of skill in the art will appreciate that the example embodiments described below are not intended to be limiting, and the SolarTough® ruggedized cable can be constructed with materials and layer thicknesses that achieve comparable functionality and performance.

In one example embodiment, the first insulation layer can be made from cross-linked polyethylene (“XLPE”). The first insulation layer is itself surrounded by a second insulation layer of high-density polyethylene (“HDPE”) that is also referred to as a “jacket.” The SolarTough® cable is generally used for applications with voltages between about 600V and about 2000V. The sizing of the SolarTough® cable varies according to electrical capacity, as illustrated below in Table 1. Sizing is provided in KCMil or “kilo circular mils,” which is a unit of area, equal to the area of a circle with a diameter of one mil (one-thousandth of an inch).

TABLE 1
SolarTough ® Cable Sizing

| Size | | Conductor | Insulation | Jacket | Overall |
|---|---|---|---|---|---|
| (AWG/ | # of | Diameter | Thickness | Thickness | Diameter |
| KCMIL) | Strands | (Mils) | (Mils) | (Mils) | (Mils) |
| 8 | 7 | 132 | 73 | 13 | 304 |
| 6 | 7 | 166 | 73 | 13 | 338 |
| 4 | 7 | 209 | 73 | 13 | 381 |
| 2 | 7 | 264 | 73 | 13 | 436 |
| 1 | 19 | 300 | 90 | 16 | 512 |
| 1/0 | 19 | 362 | 90 | 16 | 574 |
| 2/0 | 19 | 410 | 90 | 16 | 622 |
| 3/0 | 19 | 457 | 90 | 16 | 669 |
| 4/0 | 19 | 496 | 90 | 16 | 708 |
| 250 | 37 | 543 | 102 | 18 | 783 |
| 300 | 37 | 569 | 102 | 18 | 809 |
| 350 | 37 | 620 | 102 | 18 | 860 |
| 400 | 37 | 657 | 102 | 18 | 897 |
| 500 | 36 | 744 | 102 | 18 | 984 |
| 600 | 61 | 812 | 115 | 20 | 1083 |
| 700 | 61 | 877 | 115 | 20 | 1148 |
| 750 | 60 | 917 | 115 | 20 | 1188 |
| 1000 | 60 | 1059 | 115 | 20 | 1330 |
| 1250 | 90 | 1196 | 132 | 23 | 1507 |

The electrical properties in turn vary according to cable sizing, as shown in Table 2.

TABLE 2
SolarTough ® Cable Electrical Properties

| Size | Approx. | Resistance | Resistance | | Bend |
|---|---|---|---|---|---|
| (AWG/ | Weight | (Ω/kft | (Ω/kft | Ampacity | Radius |
| KCMIL) | (lb/kft) | 20° C.) | 90° C.) | 90° C. | (in) |
| 8 | 53 | 1.0504 | 1.3467 | 60 | 2.4 |
| 6 | 68 | 0.6610 | 0.8474 | 85 | 2.7 |
| 4 | 91 | 0.3300 | 0.4231 | 115 | 3.0 |
| 2 | 124 | 0.2610 | 0.3346 | 150 | 3.5 |
| 1 | 166 | 0.2070 | 0.2654 | 175 | 4.1 |
| 1/0 | 201 | 0.1640 | 0.2103 | 205 | 4.6 |
| 2/0 | 237 | 0.1300 | 0.1667 | 235 | 5.0 |
| 3/0 | 280 | 0.1030 | 0.1321 | 270 | 5.4 |
| 4/0 | 330 | 0.0810 | 0.1038 | 315 | 5.7 |
| 250 | 399 | 0.0694 | 0.0890 | 355 | 6.3 |
| 300 | 453 | 0.0578 | 0.0741 | 395 | 6.5 |
| 350 | 512 | 0.0495 | 0.0635 | 445 | 6.9 |
| 400 | 569 | 0.0434 | 0.0556 | 480 | 7.2 |
| 500 | 685 | 0.0347 | 0.0445 | 545 | 7.9 |
| 600 | 829 | 0.0289 | 0.0371 | 615 | 8.7 |
| 700 | 942 | 0.0248 | 0.0318 | 670 | 9.2 |
| 750 | 1000 | 0.0231 | 0.0296 | 700 | 9.5 |
| 1000 | 1275 | 0.0173 | 0.0222 | 845 | 10.6 |
| 1250 | 1611 | 0.0138 | 0.0177 | 965 | 12.1 |

The SolarTough® cable is produced using a specially engineered extrusion process that ensures compliance with UL Specification 4703 for photovoltaic wire. During manufacturing, a HDPE compound for the outer insulation layer is extruded simultaneously over an inner layer of pure XLPE. This co-extrusion process results in a fully cross-linked dual-layer jacket that provides exceptional durability and performance. The combined layers create a significantly tougher cable jacket with superior resistance to surface abrasion, which is critical for direct burial applications where cables are exposed to soil movement and mechanical stress. Additionally, the outer layer exhibits enhanced color fastness, maintaining its visual integrity over time even under prolonged exposure to ultraviolet (“UV”) radiation. This dual-layer design not only improves mechanical strength but also ensures long-term reliability in harsh environmental conditions, making the SolarTough® cable particularly well-suited for high-voltage solar installations.

The inner, first insulation layer of the SolarTough® cable is black, while the outer, second insulation layer is color-coded to indicate polarity, such as distinguishing the positive trunk bus from the negative trunk bus. This color differentiation simplifies installation and maintenance by providing clear visual identification of conductors. The outer layer incorporates a high concentration of color particles, which enhances color fastness and protects against UV degradation, ensuring long-term durability in outdoor environments. In contrast, the inner black insulation layer is free of color particles, particularly red pigments, which are known to cause porosity when dispersed throughout insulation material. Eliminating these pigments prevents the formation of microscopic voids, resulting in a more uniform and reliable insulating barrier. This design significantly improves the lifespan and electrical integrity of the conductor under high-voltage conditions. It should be understood that the described construction is example and not limiting; other suitable insulation materials and thicknesses may be employed to achieve comparable performance for high-voltage photovoltaic applications.

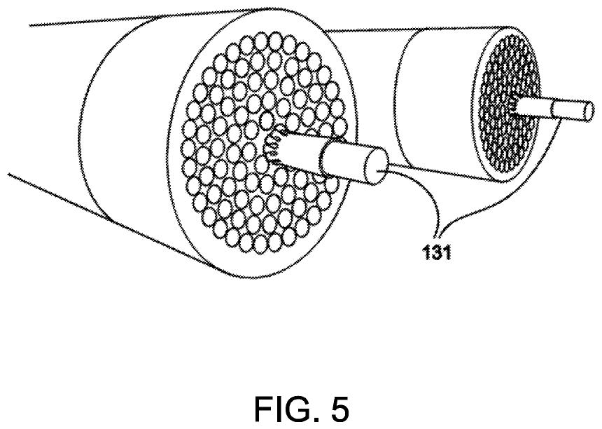

In one embodiment, the SolarTough® cable replaces some of the aluminum stranded conductors inside the cable with an aluminum coated, steel core member 131 shown in FIG. 5. The steel core member increases rigidity and strength of the bus line, which is particularly useful for applications where the bus line is suspended between vertical supports. The added strength from the steel core member 131 allows the bus line to be self-supported and span up to thirty feet between supports without the need for hangers that are used in conventional systems to support the trunk bus line.

Notably, steel is not as conductive as aluminum, which can result in a conductivity loss by replacing some of the aluminum strands in a cable with the steel core. Coating the steel core member with aluminum mitigates against the loss of conductivity and in part takes advantage of the “skin effect” where current tends to become concentrated near the exterior surface of a cable conductor strand with a circular cross section. Thus, coating the steel core member with aluminum places a higher conductivity material where the current tends to concentrate. Utilizing an aluminum coating can recapture about 70% of the current capacity that would have otherwise been lost when using a steel core member itself without the coating.

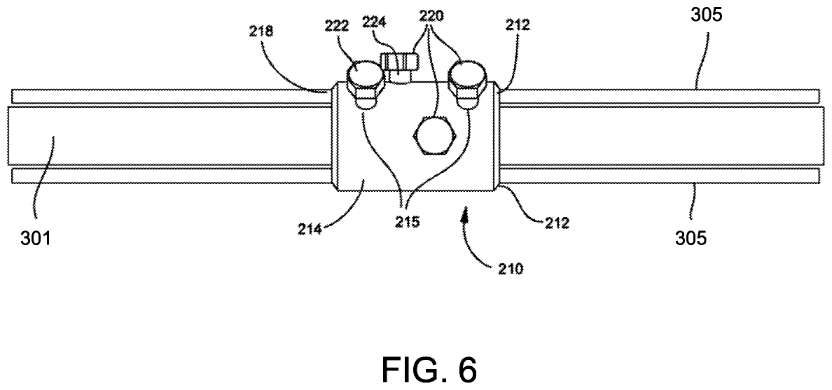

Once the trunk bus line 301 is installed, the solar panel arrays 310 can be connected to the trunk bus line 301 using multi-tap penetrating connectors 210, such as the shear-bolt connectors shown in FIGS. 6-10. The connectors 210 are disposed about the trunk bus lines 301 and include a plurality of taps 212 for receiving portions of PV wire harnesses 305. The multi-tap shear bolt connectors 210 show favorable temperature performance under high current conditions, and importantly, the connectors 210 obviate the need for combiner boxes that are prone to overheating and failure.

The connectors 210 include a hollow body portion (e.g., a housing 214) with one or more socket openings 218 defining the interior of the housing 214 or socket. The socket or through-socket is a continuous channel extending through the entire length of the hollow body portion. The socket is configured to accommodate and firmly secure a conductor (i.e., a cable) that extends through the length of the hollow body portion, such as the positive trunk bus line or the negative trunk bus line. The socket may define a continuous channel through the housing 214, or the socket can be formed from halves or shells of the connector housing 214 joined to form a channel.

Conductors (e.g., the positive and negative trunk bus lines) are secured within the socket by shear bolt fasteners 220 that extend through passages 215 in the connector housing 214 to penetrate through the conductor insulation and into the interior of the conductor material. In this manner, the fasteners 220 establish metal-to-metal conductive contact between the conductor interior and the connector housing 214.

The head 222 of the shear-bolt fasteners 220, and in some cases part of the stem 224, is designed to shear off when the fasteners 220 are subjected to a predetermined torsion load. At least a portion of the shear-bolt stem 224 remains within the passage 215 after shearing. Preferably, the fastener 220 shears such that the stem 224 does not extend beyond the exterior surface of the connector housing 214. Notably, the connector 210 is not limited to a shear bolt connector, and the taps 212 can likewise be formed in other types of connectors and used to support the bus systems disclosed herein.

The solar panel arrays 310 are placed in electrical communication with the multi-tap connector 210 and trunk bus 130 by inserting portions of the wire harnesses 305 into the connector taps 212. In particular, insulation is stripped from a portion of photovoltaic wire extending from the wire harness 305, and the exposed photovoltaic wire is placed within the tap 212 and held in place with a set screw (not shown). This places the photovoltaic wire harness 305 in electrical communication with the connector housing 214 and the conductor within the socket (i.e., the positive or negative trunk bus line).

### Installation

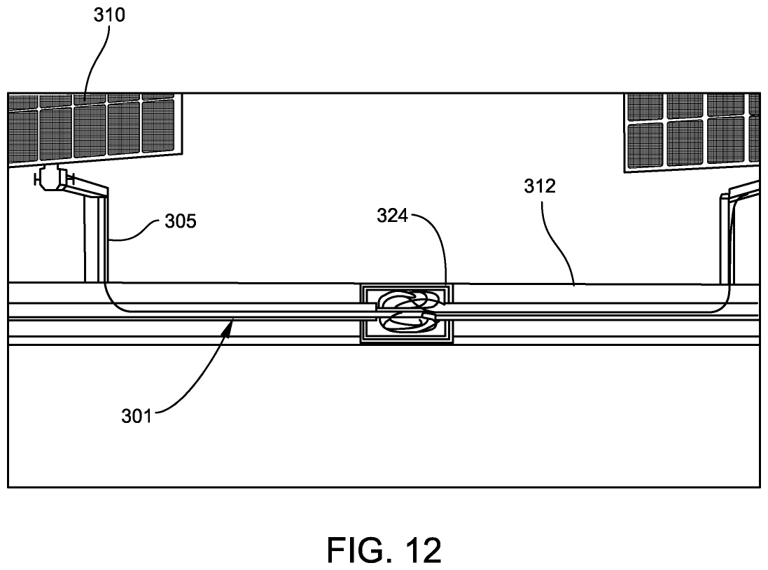

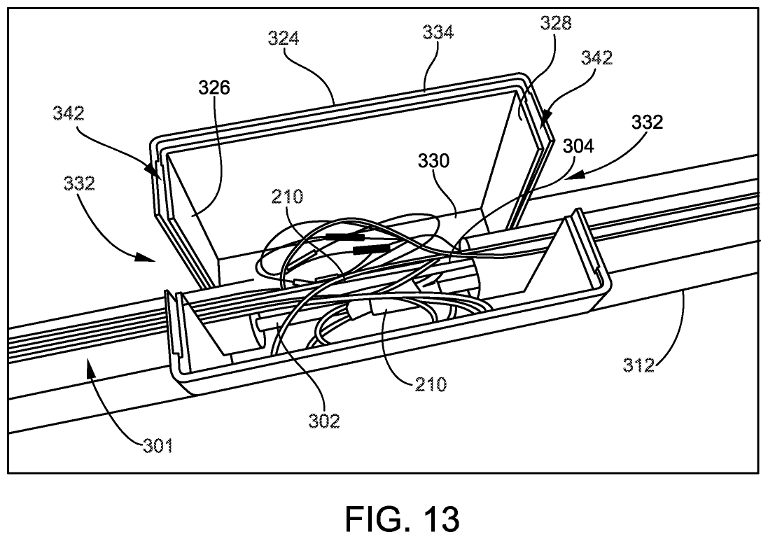

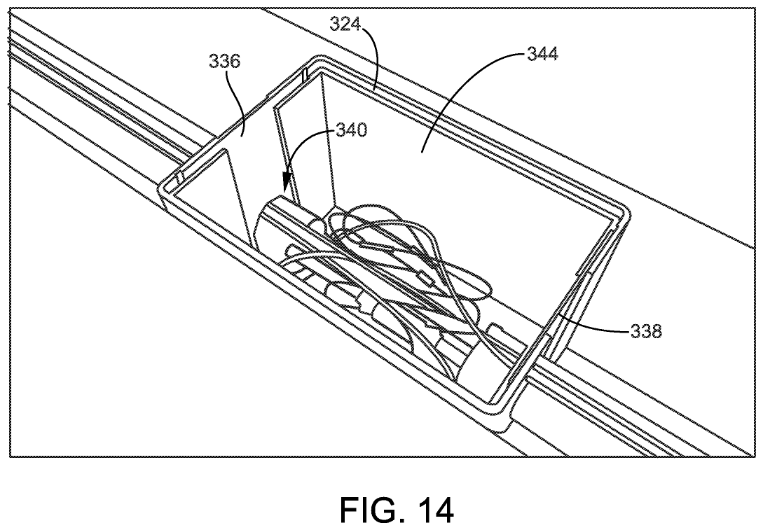

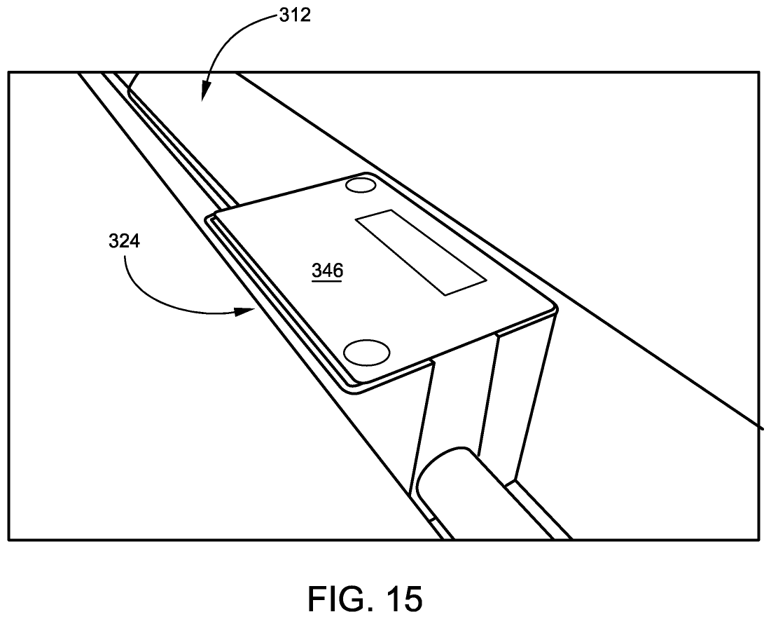

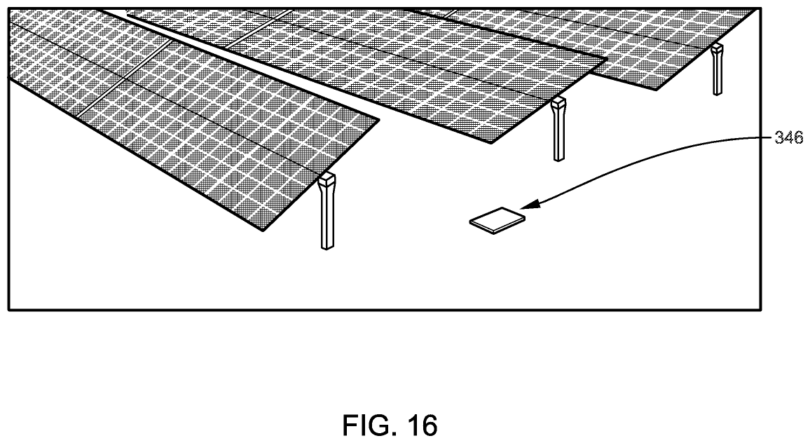

As illustrated in FIGS. 11-16, unlike traditional installation of below grade cables, the system 300 is not completely buried below grade and does not require a wide trench to be formed using machinery such as a backhoe which is inefficient and costly. Rather, the system 300 forms a narrow trench 312 and feeds the positive and negative trunk buses 302 and 304 directly into the narrow trench 312 simultaneously.

As illustrated, the trench 312 is formed using machinery such as a bulldozer 314. It should be appreciated that other suitable machinery may be used. The bulldozer 314 includes one or more spools 316 of positive and negative trunk buses 302 and 304, a ripper blade or knife 318 connected to a rear of the bulldozer 314, and a funnel system 320 connected to and spaced from the knife 318. The bulldozer 314 cuts trench 312 as the bulldozer moves forward along the solar arrays 310. At the same time, positive and negative trunk buses 302 and 304 are pulled from the spools 316 across rollers 322 disposed on the top of the bulldozer 314 and into the funnel system 320. As the knife 318 cuts the trench 312, the funnel system 320 funnels or lays the positive and negative trunk buses 302 and 304 into the trench 312. Thus, an entire positive and negative trunk 302 and 304 may be laid into the trench 312 quickly and efficiently.

At predetermined distances, a hand-hold box 324 is positioned in the trench 312 and the trunk bus line 301 is laid through first and second ends 326 and 328 and across a bottom 330 of the hand-hold box 324. The hand-hold box 324 may be installed while the trunk bus line 301 is being installed or after installation.

As shown, the first and second ends 326 and 328 each include a cutout 332 extending from a top rim 334 to the bottom 330. The cutouts 332 allow the trunk bus line to extend through the hand-hold box 324 without interruption. Once the trunk bus line 301 has been installed through the hand-hold box 324, first and second doors 336 and 338 may be installed by sliding the first and second doors 336 and 338 into channels 342 of the first and second ends 326 and 328 to close off the cutouts 332. As shown, first door 336 closes off cutout 332 of the first end 326 and second door 338 closes off cutout 332 of the second end 328. The first door 336 and the second door 338 each include an aperture 340 to accommodate the trunk bus line 301 extending therethrough.

The multi-tap penetrating connectors 210 may be installed prior to or after installation of the hand-hold box 324. The connectors 210 are positioned in an interior 344 of the hand-hold box 324 to allow easy access to the connectors 210. As shown, the positive and negative trunk buses 302 and 304 each include a connector 210. The connectors 210 allow four panel arrays 310 to connect to the trunk bus line 301, which increases the number of connection points on a bus line compared to use of combiner boxes. Increasing the number of connection points avoids the substantial heat generation that occurs at combiner boxes that might otherwise accept input from tens of panel arrays 310. Further, use of the connectors 210 permits a single trunk bus line 301 having a positive trunk bus 302 and negative trunk bus 304 to be used for a plurality of solar arrays.

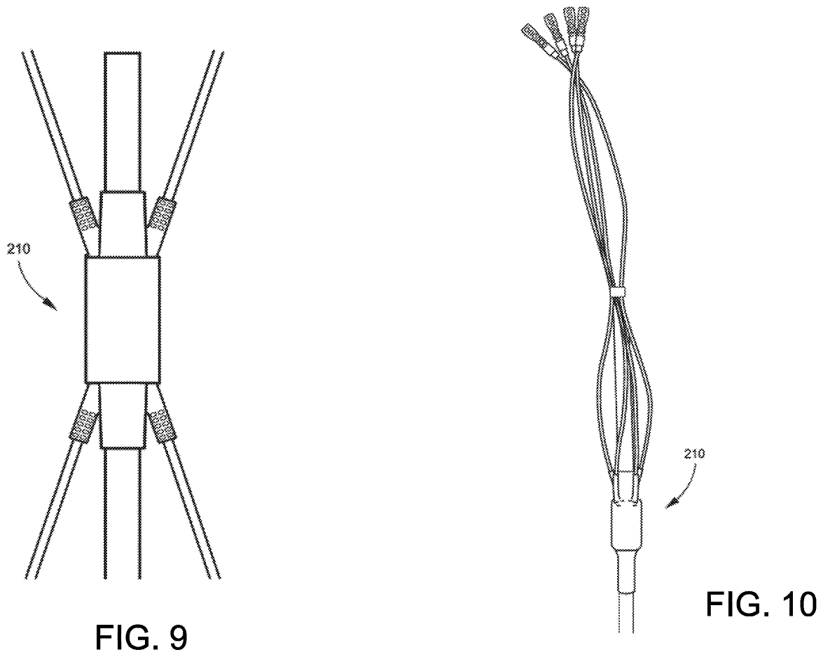

Once the multi-tap connectors 210 are installed, the connectors 210 may be sealed with an insulating material to provide mechanical support, electrical isolation, and protection from moisture (i.e., ingress protection) or other weather elements. The sealing can be accomplished prior to field installation using, for example, a molded thermoplastic elastomer, a molded thermoset elastomer, or a heat-shrink boot that encapsulates the connector 210. An example of a heat-shrink boot encapsulating the connector 210 is depicted in FIGS. 9-10. FIG. 10 illustrates the insulation partially covering four conductors (e.g., photovoltaic wires) extending from the taps of the multi-tap connector.

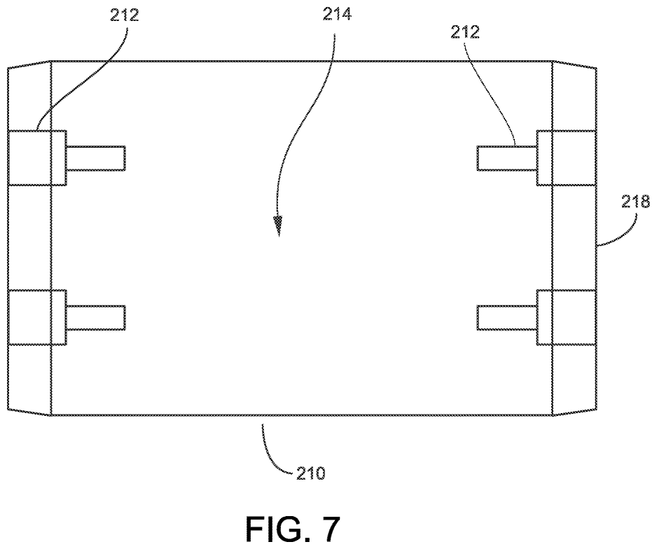

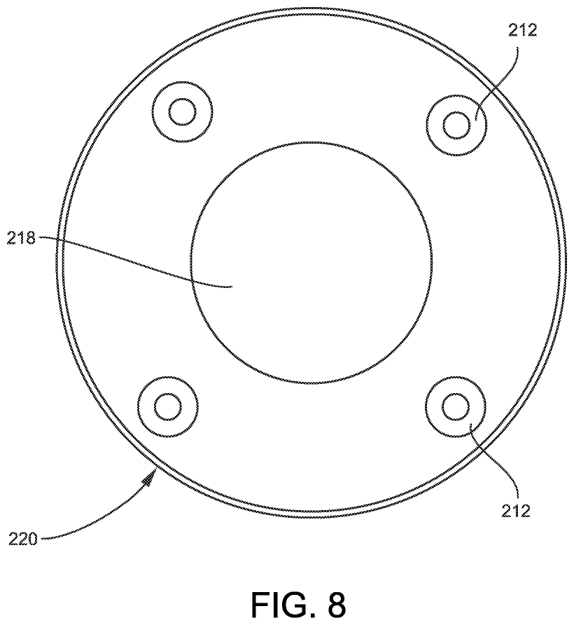

In other embodiments, the connector 210 can be provided with a sealing kit adapted for field use and installation. The field sealing kit can include an insulating sleeve, a tape, or a semi-solid paste or gel that is applied to the connector and heat-dried to shrink or conform the insulating material to the connector 210. The insulating material can be a cross-linked polyethylene or another suitable insulating polymer material. The connection can also be sealed utilizing a factory-installed heat shrink polyolefin boot that is custom designed to encapsulate the connector body and the taps 212, as shown in FIGS. 7-8.

With the trunk bus line 301 and connectors 210 installed in the hand-hold box 324, a lid 346 may be installed to enclose the interior 344 of the hand-hold box 324. PV wire harnesses 305 are connected to the solar arrays 310 and the trench 312 is filled such that only the lid 346 is visible from above grade “G”, FIG. 16.

Although the foregoing description provides embodiments of the invention by way of example, it is envisioned that other embodiments may perform similar functions and/or achieve similar results. Any and all such equivalent embodiments and examples are within the scope of the present invention.

What is claimed:

1. An unimpeded row system comprising:
(a) a solar panel array installed on a surface;
(b) a trench formed in the surface;
(c) a trunk bus within the trench;
(d) a photovoltaic wire extending from the solar panel array to the trunk bus, wherein the photovoltaic wire places the trunk bus in signal communication with the solar panel array;
(e) a multi-tap electrical connector comprising
(i) a hollow housing defining a through-socket receiving the trunk bus line, and
(ii) a plurality of taps that are each formed as a conduit extending through the hollow housing to the through-socket, wherein the photovoltaic wire extends through one of the taps; and
(f) a box positioned within the trench, wherein the box comprises a first end and a second end, wherein
(i) the first end has a first cutout and the second end has a second cutout,
(ii) the first cutout and the second cutout each extend from an upper rim toward a lower surface, and
(iii) the trunk bus line extends through the first cutout end and through the second cutout.

2. The system of claim 1, wherein the positive trunk bus comprises an inner insulation layer formed of cross-linked polyethylene and an outer jacket layer formed of high-density polyethylene.

3. The system of claim 2, wherein the trunk bus further comprises an aluminum-coated steel core member.

4. The system of claim 1, wherein the multi-tap electrical connector further comprises a shear-bolt fastener extending through a passage formed in the hollow housing and into the trunk bus line.

5. The system of claim 1, wherein the box further comprises a first door and a second door, wherein
(a) the first door is slidably received within a first channel formed in the first end;
(b) the second door is slidably received within a second channel formed in the second end;
(c) the first door comprises a first aperture configured to accommodate the trunk bus line extending therethrough; and
(d) the second door comprises a second aperture configured to accommodate the trunk bus line extending therethrough.

6. The system of claim 1, wherein the box further comprises a lid enclosing an interior of the box, wherein the lid is positioned at or below the surface.

7. The system of claim 1, wherein the multi-tap electrical connector is positioned within an interior of the box.

8. The system of claim 1, further comprising an insulating seal encapsulating the multi-tap electrical connector, wherein the insulating seal comprises at least one of a heat-shrink boot, a molded thermoplastic elastomer, or a molded thermoset elastomer.

9. An unimpeded row system comprising:
(a) a trunk bus line extending along a row of solar panel arrays, wherein the trunk bus line comprises a positive trunk bus and a negative trunk bus;
(b) a plurality of photovoltaic wires that each extend from a respective solar panel array; and
(c) a plurality of multi-tap electrical connectors mounted on the trunk bus line, wherein
(i) each multi-tap electrical connector comprises a hollow housing,
(ii) each housing has a first opening and a second opening,
(iii) each housing defines a socket that extends from the first opening to the second opening,
(iv) the socket receives the positive trunk bus or the negative trunk bus that extend through the socket, and
(v) each multi-tap connector comprises a plurality of taps receiving respective conductors of the photovoltaic wires.

10. The system of claim 9, further comprising a trench extending along the row of solar panel arrays.

11. The system of claim 10, wherein the trunk bus line is positioned below a surface grade within the trench.

12. The system of claim 10, further comprising at least one hand-hold box positioned within the trench, wherein
(a) the hand-hold box comprises a first end and a second end;
(b) the first end comprises a first cutout;
(c) the second end comprises a second cutout;
(d) the trunk bus line is positioned below a surface grade within the trench and extends through the first cutout of the first end and the second cutout of the second end.

13. The system of claim 12, wherein the hand-hold box further comprises a lid enclosing an interior of the hand-hold box, and wherein the lid is positioned at or below the surface grade.

14. The system of claim 9, wherein the positive trunk bus and the negative trunk bus each comprise a conductive cable surrounded by an inner insulation layer formed of cross-linked polyethylene and an outer jacket layer formed of high-density polyethylene.

15. The system of claim 9, wherein each multi-tap electrical connector further comprises a plurality of shear-bolt fasteners extending through passages in the hollow housing of the multi-tap electrical connector and into the trunk bus line to establish a metal-to-metal conductive contact.

16. The system of claim 9, wherein:
(a) each multi-tap electrical connector is at least partially encased within an insulating material; and
(b) the insulating seal selected from a heat-shrink boot, a molded thermoplastic elastomer, a molded thermoset elastomer, or a field sealing kit, and wherein the field sealing kit comprises at least one of an insulating sleeve, a tape, or a semi-solid paste.

17. A method of installing an unimpeded row system, the method comprising the steps:
(a) forming a trench along a row of solar panel arrays, wherein the trench extends below a surface grade;
(b) positioning a trunk bus below the surface grade within the trench;
(c) mounting a multi-tap electrical connector on the trunk bus line, wherein (i) the multi-tap electrical connector is at least partially encased with an insulating material or a field sealing kit, and (ii) the multi-tap electrical connector comprises a housing that defines a through-socket that receives the trunk bus line and a tap formed on an outer surface of the hollow housing;
(d) connecting a photovoltaic wire from respective solar panel arrays to the tap;
(e) positioning a box within the trench such that the trunk bus line extends through the box, wherein (i) the box provides access to the multi-tap electrical connector from above the surface grade, and (ii) the box comprises a first end that has a first channel and a second end that has a second channel; and
(f) positioning the trunk bus within the box such that the trunk bus extends from the first channel to the second channel.

18. The method of claim 17, wherein forming the trench comprises cutting the trench with a bulldozer having a knife connected to a rear thereof while simultaneously feeding the positive trunk bus and the negative trunk bus from one or more spools mounted on the bulldozer through a funnel system into the trench.

19. The method of claim 17, wherein the trunk bus and the negative trunk bus comprises an aluminum-coated steel core member.

20. The method of claim 17, wherein the inner insulation layer comprises cross-linked polyethylene and the outer jacket layer comprises high-density polyethylene.
